(19) United States
(12) Patent Application Publication
(10) Pub. No.: US 2007/0094454 A1
(43) Pub. Date: Apr. 26, 2007

(54) Program memory source switching for high speed and/or low power program execution in a digital processor

(75) Inventors: Steven Brundula, Chandler, AZ (US); Randy Yach, Phoenix, AZ (US); Sam Alexander, Phoenix, AZ (US); Mike Pyska, Phoenix, AZ (US); Douglas Chaffee, Queen Creek, AZ (US)

Correspondence Address: BAKER BOTTS, LLP, 910 LOUISIANA, HOUSTON, TX, 77002-4995, US

(73) Assignee: Microchip Technology Incorporated

(21) Appl. No.: 11/254,373

(22) Filed: Oct. 20, 2005

(51) Int. Cl. G06F 13/00

(52) U.S. Cl. 711/154

(57) ABSTRACT

An integrated circuit digital processor is coupled to either a main program memory or a secondary program memory, wherein the secondary program memory may be low power, high reliability, non-volatile and/or fast memory that may store a limited number of critical program instructions and data for execution by the digital processor. A program memory switch may couple the digital processor to either the main program memory or the secondary program memory. This is particularly advantageous in that the secondary program memory may have attributes not economically feasible with the main program memory. A program memory controller may handle the selection of which of these memories that the digital processor is using to obtain its program instructions, and necessary control signals for switching and operation thereof.

### TECHNICAL FIELD

The present disclosure, according to one embodiment, relates to integrated circuit digital processors and, more particularly, to program source switching of memories for high speed and/or low power program execution by the integrated circuit digital processor.

### BACKGROUND

Integrated circuit digital processors are widely used for many different applications. More and more of these applications may require high speed and/or low power operation of the integrated circuit digital processor. Many applications are intermittent in that operation of the digital processor may be on an as needed basis, so a sleep mode may be incorporated into the design and operation of the digital processor. However when operation is required, a wake-up sequence of the digital processor may be initiated. A digital processor typically uses a sequence of program steps that are stored in a program memory that may be non-volatile, or volatile with a battery back-up. As the sophistication of the applications using the digital processors increase, so do the number of program steps and size of program memory necessary. This increases power usage and the length of time required to go from a power conserving “sleep mode” to an “operating mode.” Larger size program memory either must consume more power, or be of a type of memory that is lower in power and may be slower in operation. Having to rely upon a high power consuming memory and/or slow memory for all applications is both wasteful and unnecessarily time consuming. In addition, various peripheral devices may share the same program memory and pre-empt operation of the digital processor, e.g., interrupt servicing of the peripheral doing a direct memory access. Some mission critical applications require a high reliability and/or redundant memory. Making a large capacity memory that is highly reliable and/or redundant both expensive and power wasteful.

### SUMMARY

Applications requiring low power operation, fast wake-up, redundant high reliability, and/or dedicated operation with a digital processor need a lower power consuming and/or faster program memory. Main program memory may not be available to the digital processor because of power conservation (e.g., in a sleep mode), use by another peripheral, and/or fault conditions of the main program memory. Therefore, there is a need for a lower power consuming and/or faster program memory that may be used for applications requiring low power operation, fast wake-up, redundant high reliability, and/or dedicated operation with a digital processor.

A secondary program memory, according to specific example embodiments of this disclosure, may be used to (1) reduce operating power, (2) provide quickly modifiable program information, e.g., instructions, data, etc., (3) provide a source of program information that is available immediately after waking from a sleep mode, and/or (4) provide a source of program information that may be accessed faster then from a typical program memory for increased speed of program execution. A digital processor may be, for example, a microprocessor, microcontroller, digital signal processor (DSP), application specific integrated circuit (ASIC), programmable logic array (PLA), and the like.

According to a specific example embodiment of this disclosure, an integrated circuit digital processor may be coupled to either a main program memory or a smaller storage capacity secondary program memory, wherein the secondary program memory may be low power, high reliability, non-volatile and/or fast memory that may store a limited number of critical program information for execution by the digital processor. A program memory switch may couple the digital processor to either the main program memory or the secondary program memory. This is particularly advantageous in that the secondary program memory may have attributes not economically feasible with the main program memory. A program memory controller may handle the selection of which of these memories the digital processor is using to obtain its program information, and necessary control signals for switching and operation thereof.

### BRIEF DESCRIPTION OF THE DRAWINGS

A more complete understanding of the present disclosure thereof may be acquired by referring to the following description taken in conjunction with the accompanying drawings wherein:

FIG. 1 is a schematic block diagram of a prior technology digital processor and program memory; and

FIG. 2 is a schematic block diagram of an integrated circuit digital device having selectable main and secondary program memories, according to a specific example embodiment of the present disclosure.

While the present invention is susceptible to various modifications and alternative forms, specific example embodiments thereof have been shown in the drawings and are herein described in detail. It should be understood, however, that the description herein of specific example embodiments is not intended to limit the disclosure to the particular forms disclosed herein, but on the contrary, this disclosure is to cover all modifications and equivalents as defined by the appended claims.

### DETAILED DESCRIPTION OF SPECIFIC EMBODIMENTS

Referring now to the drawings, the details of a specific exemplary embodiment of the present invention is schematically illustrated. Like elements in the drawings will be represented by like numbers, and similar elements will be represented by like numbers with a different lower case letter suffix.

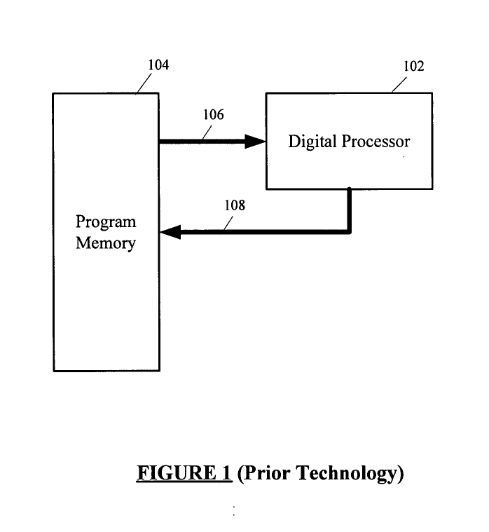

Referring to FIG. 1, depicted is a schematic block diagram of a prior technology digital processor and program memory. A digital processor 102 selects program information, e.g., instructions, data, etc., stored in a program memory by addressing the desired program information over an address bus 108 (e.g., from a program counter in the digital processor), and receives the addressed program information over an program information bus 106. The digital processor 102 may only operate as fast as can the program memory 104. If the program memory 104 is in a standby mode, has an error, or is being accessed by a direct memory access peripheral (not shown), the digital processor 102 must wait for the requested instruction or not operate at all.

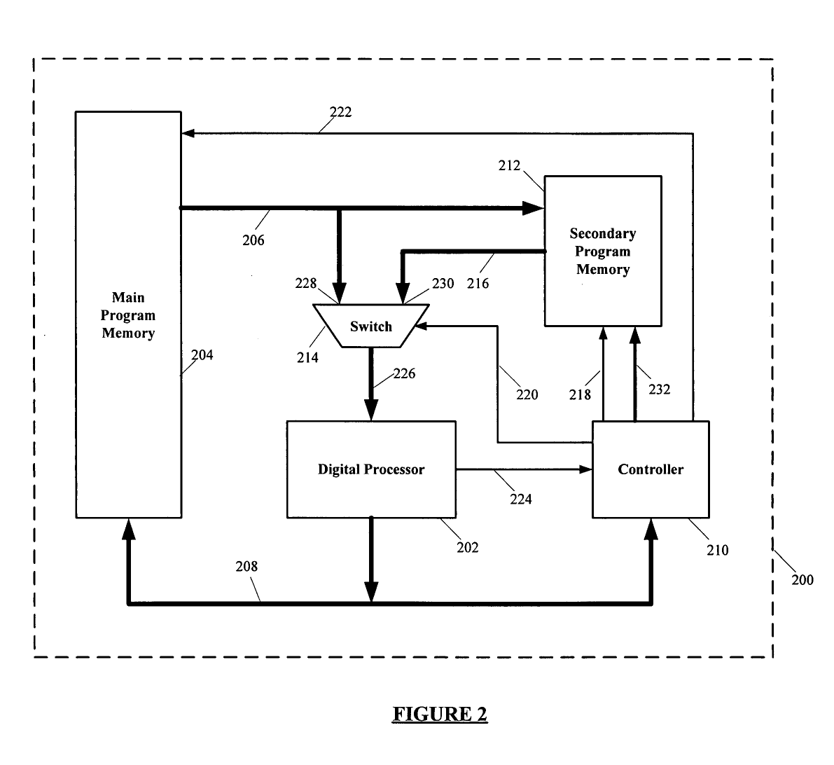

Referring to FIG. 2, depicted is a schematic block diagram of an integrated circuit digital device having selectable main and secondary program memories, according to a specific example embodiment of the present disclosure. The integrated circuit digital device, generally represented by the numeral 200, comprises a digital processor 202, main program memory 204, secondary program memory 212, program memory controller 210 and program memory switch 214. The digital processor 202 asserts program information addresses (e.g., from a program counter not shown) on the program address bus 208. The program address bus 208 couples the program information addresses asserted by the digital processor 202 to the main program memory 204 and the program memory controller 210. The program memory controller 210 may translate the program information addresses asserted by the digital processor 202 into addresses for the secondary program memory 212 over secondary address bus 232. The program memory controller 210 may also just pass through the program information addresses from the program address bus 208 to the secondary address bus 232 without address translation.

A first program information bus 206 couples program information, stored in the main program memory 204, to the secondary program memory 212 and a first input 228 of the program memory switch 214. Program information stored in the secondary program memory 212 is coupled to a second input 230 of the program memory switch 214 over a second program information bus 216. The program memory switch 214 couples either the first program information bus 206 or the second program information bus 216 to a third program information bus 226 which then allows the digital processor 202 to execute program information from either the main program memory 204 or the secondary program memory 212.

The digital processor 202 may initiate a program memory selection request to the program memory controller 210 over a switch program information signal line 224. The program memory selection request my be a program step or a predefined event, e.g., wake-up, power-up, low-power mode, etc. Once the program memory controller 210 has been instructed as to which memory will be used for retrieving program information to the digital processor 202, the program memory controller 210 will control the program memory switch 214 over switch control signal line 220 to either couple the first program information bus 206 to the third program information bus 226 or couple the second program information bus 216 to the third program information bus 226, and either enable or disable the main program memory 204, respectively, over the enable/disable signal line 222. When the digital processor 202 is coupled to the secondary program memory 212, the program memory controller 210 may also enable the secondary program memory 212 over control signal line 218. The control signal line 218 may also be adapted for enabling the secondary program memory 212 so that it may store selected program information from the main program memory 204 over the first program information bus 206.

The digital processor 202 may be, for example, a microprocessor, microcontroller, digital signal processor (DSP), application specific integrated circuit (ASIC), programmable logic array (PLA), and the like. The digital device 200 may be fabricated in a semiconductor integrated circuit and enclosed in an integrated circuit package (not shown).

The main program memory 204 may be any type of memory comprising volatile and/or non-volatile memory cells for storage of the program information. The secondary program memory 212 may also be any type of memory, preferably smaller, lower power, faster and/or more robust then the main program memory 204. Preferably the secondary program memory 212 may be more robust, for example but not limited to, volatile or non-volatile, error detecting and/or error correcting memory, operation over a wider range of voltage and/or temperature conditions, higher speed or lower power, e.g., static random access memory (SRAM).

The secondary program memory 212 may advantageously provide lower current consumption and/or faster read cycle operation then the main program memory 204. The secondary program memory 212 may advantageously provide substantially immediate availability of program information when the digital device 200 wakes up when in a low power mode. The secondary program memory 212 may also advantageously store and mirror program information from the main program memory 204. When critical program information has been stored in the secondary program memory 212, the main program memory 204 may be put into a standby mode or turned off for further power savings. The secondary program memory 212 may also operate like cache memory when enabled to do so, e.g., most frequently used program information will be read from the secondary program memory 212 instead of the main program memory 204. The secondary program memory 212 may also be adapted for and used as a redundant program memory when there may be a high probability that program information may be corrupted, such as during brown-out, power-up or electro-static discharge (ESD) events.

The program memory switch 214 couples program information from either the main program memory 204 or the secondary program memory 212 to the digital processor 202 and may comprise a digital multiplexer(s) having a bit width equal to the program information bit width. The program memory switch 214 may also be a serial data switch for coupling serially formatted program information from either the main program memory 204 or the secondary program memory 212 to the digital processor 202.

The program memory controller 210 controls operation of the program memory switch 214 and may enable and/or disable the main program memory 204 or the secondary program memory 212. It may also enable write operations to the secondary program memory 212, e.g., mirroring main program memory 204 program information for cache purposes, memory redundancy, program memory back-up, and/or increase of the program execution speed. The program memory controller 210 may also determine which program information to read from the secondary program memory 212, and may do address translations of the program information memory locations between the main program memory 204 or the secondary program memory 212. The program memory controller 210 may also enable and disable a system clock generator (not shown) if required e.g., when waiting for the main program memory to wake-up.

The program memory controller 210 may keep track of the contents (e.g., program information) of the secondary program memory 212 by using (1) “Configurable Addressing Mode”—where each location of the secondary program memory 212 may be mapped to any location of the main program memory 204, or (2) “Linear Addressing Mode”—where the program information starts at a defined (hardware or software defined) location and is within a sequentially defined number of addresses according to the number of memory locations required by the operating program.

The program memory controller 210 may store program information, e.g., instructions, data, etc., in the secondary program memory 212 by using: (1) “Register Write”—where registers may be written to with the program information to be stored and the address to store the program information as well as registers to control moving the program information from the registers to the secondary program memory 212. Register Write may be used with both the Configurable Addressing Mode and the Linear Addressing Mode. (2) “Background Copy”—where when program information is being executed from the main program memory 204 the secondary program memory 212 continuously stores the contents of the last x locations of the main program memory 204. Background Copy may be used with the Configurable Addressing Mode. Or (3) “Bulk Copy”—where upon power-up or at any time during program execution, either a predefined or software controlled range of program memory may be bulk loaded in the secondary program memory 212. Program execution may halt upon the initiation of a Bulk Copy. Bulk Copy may be used with the Linear Addressing Mode.

The program memory controller 210 in combination with the program memory switch 214 may switch memory sources (e.g., the main program memory 204 or the secondary program memory 212) for program execution as follows: (1) “Redundant Switchover”—whenever the contents (program information) of a memory address is requested by the digital processor 202 that is stored in the secondary program memory 212, the main program memory 204 may be disabled and the secondary program memory 212 may be selected and enabled. This allows interrupts to execute from the faster secondary program memory 212, and/or when waking up from a sleep mode, if the sleep mode wake-up program information is at the end of the secondary program memory 212.

(2) “State Switchover”—whenever a register is in a particular logic state the secondary program memory 212 is selected as the source of the program information (e.g., operational codes), otherwise the main program memory 204 may be selected. The State Switch mode may optionally work with the Redundant Switch mode, e.g., if a register is enabled, execution from the main program memory 204 may be forced to be the source of the program information when the main program memory 204 is ready. This allows enabling the main program memory 204 before it is needed.

And (3) “Interrupt Switchover”—whenever a predetermined event occurs, such as a memory stable flag (not shown) of the main program memory 204, it may switch the memory source for the program information back to the main program memory 204. The memory stable flag may be a bit in a status register of the main program memory 204.

The invention, therefore, is well adapted to carry out the objects and attain the ends and advantages mentioned, as well as others inherent therein. While the invention has been depicted, described, and is defined by reference to specific embodiments of the invention, such references do not imply a limitation on the invention, and no such limitation is to be inferred. The invention is capable of considerable modification, alteration, and equivalents in form and function, as will occur to those ordinarily skilled in the pertinent arts and having the benefit of this disclosure. The depicted and described specific embodiments of the invention are exemplary only, and are not exhaustive of the scope of the invention. Consequently, the invention is intended to be limited only by the spirit and scope of the appended claims, giving full cognizance to equivalents in all respects.

What is claimed is:

1. An integrated circuit digital device, comprising:
a digital processor;
a main program memory;
a secondary program memory;
a program memory switch coupled to the digital processor, the main program memory and the secondary memory, wherein the program memory switch selectably couples the digital processor to either the main program memory or the secondary program memory; and
a program memory controller, wherein the program memory controller controls the program memory switch, the secondary program memory and the main program memory.

2. The integrated circuit digital device according to claim 1, wherein the digital processor asserts program memory addresses to the main program memory and the program memory controller.

3. The integrated circuit digital device according to claim 2, wherein the program memory controller asserts translated program memory addresses to the secondary program memory.

4. The integrated circuit digital device according to claim 3, wherein the translated program memory addresses use a configurable addressing mode wherein each address location of the secondary program memory is mapped to a respective address location of the main program memory.

5. The integrated circuit digital device according to claim 3, wherein the translated program memory addresses use a linear addressing mode wherein the secondary program memory starts at a defined address location and subsequent address locations are within a sequentially defined number of addresses according to the number of memory locations required by an operating program.

6. The integrated circuit digital device according to claim 1, wherein a register write operation of the program memory controller writes program information, addresses to store the program information and control information for moving the program information from the main program memory to the secondary program memory.

7. The integrated circuit digital device according to claim 6, wherein the register write operation uses a plurality of registers for writing the program information, and addresses for storing the program and control information.

8. The integrated circuit digital device according to claim 1, wherein the program memory controller uses a background copy operation for writing program information that is being executed from the main program memory to the secondary program memory and the secondary program memory continuously stores a most recent number of executed program information.

9. The integrated circuit digital device according to claim 1, wherein the program memory controller uses a bulk copy operation to load a predefined range of program information in the main program memory to the secondary program memory.

10. The integrated circuit digital device according to claim 9, wherein the bulk copy operation is performed during a power-up of the digital processor.

11. The integrated circuit digital device according to claim 9, wherein the bulk copy operation is performed during program execution in the digital processor.

12. The integrated circuit digital device according to claim 11, wherein program execution in the digital processor is halted during the bulk copy operation.

13. The integrated circuit digital device according to claim 1, wherein the program memory switch couples the digital processor to the secondary program memory whenever the digital processor requests program information that is stored in the secondary program memory.

14. The integrated circuit digital device according to claim 1, wherein the program memory switch couples the digital processor to the main program memory whenever a certain interrupt event occurs.

15. The integrated circuit digital device according to claim 1, wherein the certain interrupt event is a main program memory stable flag.

16. The digital device according to claim 1, wherein the digital processor is selected from the group consisting of a microprocessor, microcontroller, digital signal processor (DSP), application specific integrated circuit (ASIC), and programmable logic array (PLA).

17. The digital device according to claim 1, wherein the digital processor initiates operation of the program memory controller.

18. The digital device according to claim 1, wherein the program memory controller enables and disables the main program memory.

19. The digital device according to claim 1, wherein the program memory controller enables and disables the secondary program memory.

20. The digital device according to claim 1, wherein the secondary program memory uses less operating power than the main program memory.

21. The digital device according to claim 1, wherein the secondary program memory operates faster then the main program memory.

22. The digital device according to claim 1, wherein the secondary program memory has error detection.

23. The digital device according to claim 1, wherein the secondary program memory has error detection and correction.

24. The digital device according to claim 1, wherein the digital processor, the main program memory, the secondary program memory, the program memory switch and the program memory controller are fabricated on a semiconductor integrated circuit.

25. The digital device according to claim 24, wherein the semiconductor integrated circuit is enclosed in an integrated circuit package.

26. A method for instruction redundancy and source switching in a semiconductor integrated circuit digital device, said method comprising the step of:
coupling a digital processor to either a main program memory or a secondary program memory depending upon a preferred mode of operation.

27. The method according to claim 26, wherein the preferred mode of operation is low power operation.

28. The method according to claim 26, wherein the preferred mode of operation is high speed operation.

29. The method according to claim 26, wherein the preferred mode of operation is error detection and correction operation.

30. The method according to claim 26, wherein the digital processor is coupled to the secondary memory when the digital processor is in a power-up mode of operation.

31. The method according to claim 26, wherein the step of coupling a digital processor to either a main program memory or a secondary program memory is done with a program memory switch.

32. The method according to claim 31, further comprising the step of controlling the program memory switch with a program memory controller.

33. The method according to claim 32, wherein the step of controlling by the program memory controller is initiated by the digital processor.

34. The method according to claim 26, wherein the digital processor is coupled to the secondary program memory when the digital processor is in low power mode.

35. The method according to claim 34, wherein the digital processor is coupled to the secondary program memory until the digital processor exits the low power mode then the digital processor is coupled to the main program memory.
